(19) United States
(12) Patent Application Publication
(10) Pub. No.: US 2010/0106962 A1
(43) Pub. Date: Apr. 29, 2010

(54) METHOD, APPARATUS, AND SYSTEM FOR MANAGING MULTIMEDIA SERVICES

(75) Inventor: Xu Chen, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/649,834

(22) Filed: Dec. 30, 2009

Related U.S. Application Data
(63) Continuation of application No. PCT/CN2008/071147, filed on May 30, 2008.

(30) Foreign Application Priority Data
Sep. 30, 2007 (CN) 200710149994.3

(51) Int. Cl. H04L 29/06

(52) U.S. Cl. 713/153

(57) ABSTRACT

A method for managing multimedia services includes the following steps: A session receiver sends Real-time Transport Control Protocol (RTCP) packets to a distribution aggregation point, and each distribution aggregation point is connected to at least one session receiver and aggregates the received RTCP packets into the first aggregated packet whose format is different from the format of the RTCP packets; the distribution aggregation point sends the first aggregated packet to a distribution source over a transmission network, and the distribution source aggregates the aggregated packet into a second aggregated packet, and then processes the second aggregated packet and transmits it to a session sender, or transmits the second aggregated packet to the session sender directly. The present invention implements feedback of mass packets from the session receiver to the sender in large-scale multicast applications, and avoids the unicast bottleneck.

### CROSS-REFERENCE TO RELATED APPLICATIONS

This application is a continuation of International Application No. PCT/CN2008/071147, filed on May 30, 2008, which claims priority to Chinese Patent Application No. 200710149994.3, filed on Sep. 30, 2007, both of which are hereby incorporated by reference in their entireties.

### FIELD OF THE INVENTION

The present invention relates to communications technologies, and in particular, to a method, an apparatus, and a system for managing multimedia services.

### BACKGROUND OF THE INVENTION

In the multimedia communication field, the Real-time Transport Control Protocol (RTCP) provides multimedia traffic control and congestion control. The participants in a multimedia session transmit RTCP packets periodically so that the server can change the transmission rate and load type of the real-time data dynamically according to the feedback information about the transmission quality, thus maximizing the transmission efficiency.

In a Real-time Transport Protocol (RTP) multicast session, the Media Sender (MS) sets up an RTP session with the receiver through a signaling protocol, then the real-time multimedia data is generally carried over an RTP protocol, and delivered to the end user through an Internet Protocol (IP) multicast protocol. The MS sends Sender Report (SR) packets to all session receivers by means of multicast to control various parameters of the session transmission dynamically. Each session receiver constructs a Receiver Report (RR) packet according to the session receiver's own session quality features, and feeds back the packet to the data sender by means of unicast. When the unicast feedback mode is applied to the Internet Protocol Television (IPTV) service, the sender of the multimedia data needs to process the RR packets from tens of thousands of session receivers within an RTCP report period. With the increase of the IPTV receivers, too centralized network traffic and operation load threaten the stability of the IPTV system. The RR packet needs to be fed back to the session sender periodically. Supposing Td is a feedback period, every session receiver generates an RR packet at an interval of Td. Therefore, within a Td interval, the session sender needs to process N feedback packets from the receivers simultaneously, where N is the actual number of session receivers. The number of receivers of the IPTV service is enormous, and numerous RR packets are generated within each Td interval. By default, the bandwidth occupied by the RTCP packet is 5% of the total bandwidth of the session, and the bandwidth occupied by the RR packets tends to exceed that percentage. Consequently, too many RTP channels are occupied, and the transmission quality of the multimedia data is affected, and the IPTV bearer network undertakes a huge traffic load. Besides, the IPTV sender needs to process numerous packets within a Td interval, thus bringing a huge processing load to the sender server. Therefore, in the large-scale multicast RTP application of IPTV, the feedback of mass RR packets leads to a unicast bottleneck, affects the transmission Quality of Service (QoS) of the IPTV data seriously, and increases the processing load of the IPTV system.

In a technical solution in a related art, the rate of generating the RR packets is decreased through extension of Td. In this way, the feedback packets occupy fewer transmission bandwidths, and the normal transmission of the RTP channel is ensured, and the transmission quality of the multimedia data is ensured. Besides, this solution may increase the time of the sender processing the packets from the receiver. In this way, the sender has much more time to process the feedback packets from each receiver, and the processing pressure of the sender server is relieved.

In the process of research and practice, the inventor finds that: With increase of the session receivers, the increase of Td takes precedence over real-time monitoring, and the stability of system processing is achieved at the cost of the monitoring quality. If the number of receivers is too huge, the required Td interval is great, and real-time monitoring makes no sense.

In another solution in a related art, the end-to-end RTP communication architecture and the RTCP packet are extended, and two logical components, distribution source and feedback target, are introduced into the end-to-end communication architecture. In the multimedia session data channel, the distribution source is responsible for obtaining the multimedia data of the multimedia sender through unicast, and delivering the multimedia data to the session receiver through multicast. In the multimedia session control channel, the RR packets of each receiver are provided to the feedback target first, and the feedback target aggregates all received RR packets into a Receiver Summary Information Report (RSI) packet, and then feeds back the aggregated RSI packet to the distribution source. The distribution source processes the RSI packet and generates an SR packet, and delivers the SR packet to each session receiver through the multicast channel. The SR packet includes the session quality statistic information of the entire group, and the session receiver adjusts the transmission policy dynamically according to the statistic information. However, due to the centralized processing feature of the distribution source and the feedback target, the distribution source and the feedback target are generally deployed near the session sender on the actual network, and each RR packet still needs to traverse the transmission network before aggregation, thus making it impossible to increase the utilization of the network bandwidth. Besides, the RR packets that previously need to be processed by the session sender are now processed by the distribution source and the feedback terminal jointly; the operation load caused by centralized processing is not decreased; and the unicast bottleneck caused by mass unicast packets persists.

### SUMMARY OF THE INVENTION

Embodiments of the present invention provide a method, an apparatus, and a system for managing multimedia services to provide feedback of mass packets from a session receiver to a sender in large-scale multicast applications and avoid the unicast bottleneck.

In a method for managing multimedia services in an embodiment of the present invention, a distribution aggregation point is set at a receiver side, and a distribution source is set near a sender side. The method includes:

receiving a first aggregated packet that is sent by the distribution aggregation point and obtained by aggregating a RTCP packets sent by a receiver; and

performing a second aggregation on the first aggregated packet at the distribution source to obtain a second aggregated packet, and transmitting the second aggregated packet.

A system for managing multimedia services in an embodiment of the present invention includes a distribution aggregation point and a distribution source.

The distribution aggregation point is located near a session receiver side and the distribution aggregation point includes a first receiving unit, a first aggregating unit, and a first transmitting unit, wherein:

the first receiving unit is configured to receive RTCP packets sent by the session receiver;

the first aggregating unit is configured to aggregate the RTCP packets into a first aggregated packet; and

the first transmitting unit is configured to transmit the first aggregated packet.

The distribution source is located near a session sender side and the distribution source includes a second receiving unit, a second aggregating unit and a second transmitting unit, wherein:

the second receiving unit is configured to receive the first aggregated packet;

the second aggregating unit is configured to aggregate the first aggregated packet received by the second receiving unit to obtain a second aggregated packet; and

the second transmitting unit is configured to transmit the second aggregated packet.

An apparatus for managing multimedia services in an embodiment of the present invention includes a second receiving unit, a second aggregating unit and a second transmitting unit, wherein:

the second receiving unit is configured to receive a first aggregated packet;

the second aggregating unit is configured to aggregate the first aggregated packet into a second aggregated packet; and

the second transmitting unit is configured to transmit the second aggregated packet.

Through the technical solution of the embodiment of the present invention, the distribution source receives a first aggregated packet over the transmission network, thus avoiding the unicast bottleneck caused by feedback of mass RTCP packets. In addition, the received first aggregated packet is aggregated for a second time so that the packet processing load of the distribution source is shared by the distribution source and the distribution aggregation point. This may avoid the unicast packet bottleneck caused by feedback of mass packets from the session receiver to the sender.

### BRIEF DESCRIPTION OF THE DRAWINGS

FIG. 1 is a flowchart of a method for managing multimedia services provided in a first embodiment of the present invention;

FIG. 2 is a flowchart of a method for managing multimedia services provided in a second embodiment of the present invention;

FIG. 3 shows a multimedia service management system provided in an embodiment of the present invention; and

FIG. 4 shows a multimedia service management apparatus provided in an embodiment of the present invention.

### DETAILED DESCRIPTION OF THE INVENTION

The embodiments of the present invention provide a method, an apparatus, and a system for managing multimedia services to provide feedback of mass packets from the session receiver to the sender in large-scale multicast applications, and thus avoiding the unicast bottleneck. To make the technical solution of the present invention clearer, the following describes the embodiments of the present invention in detail with reference to accompanying drawings.

A method for managing multimedia services that is provided in an embodiment of the present invention is described as follows:

One or more distribution aggregation points are set near a session receiver; one or more receivers are in a one-to-one or many-to-one relationship with the distribution aggregation points. That is, one distribution aggregation point corresponds to at least one receiver. First, a session receiver sends an RR packet to a corresponding distribution aggregation point. When receiving the RR packets from each receiver, each distribution aggregation point aggregates the received RR packet(s) into a first aggregated packet whose format is different from the format of the RR packet, and then sends the first aggregated packet to a distribution source near the session sender over a transmission network. In the embodiments of the present invention, the distribution source is in a one-to-one or one-to-many relationship with the distribution aggregation point. When receiving the first aggregated packet from each distribution aggregation point, the distribution source aggregates the first aggregated packets to acquire a second aggregated packet, and then transmits the second aggregated packet. The distribution source transmits the second aggregated packet in this way: The distribution source processes the second aggregated packet and sends it to the session sender, or sends the second aggregated packet to the session sender directly. In an embodiment of the present invention, the distribution source and the distribution aggregation point are deployed at the session sender and the session receiver respectively, and the RR packets are aggregated twice. This enables feedback of mass packets to be provided from the session receiver to the sender, and the unicast bottleneck caused by feedback of mass packets is improved.

In an exemplary solution of the present invention, a group key management server authenticates the distribution source and the distribution aggregation point, and the distribution source and the distribution aggregation point that pass the authentication may encrypt and decrypt the first aggregated packet by using the traffic encryption policy delivered by the group key management server. Because the distribution aggregation point and the distribution source are separately deployed at two sides of the transmission network, the authentication may improve the security of transmitting the first aggregated packet on the transmission network.

The multimedia service management method provided in an embodiment of the present invention is detailed as follows:

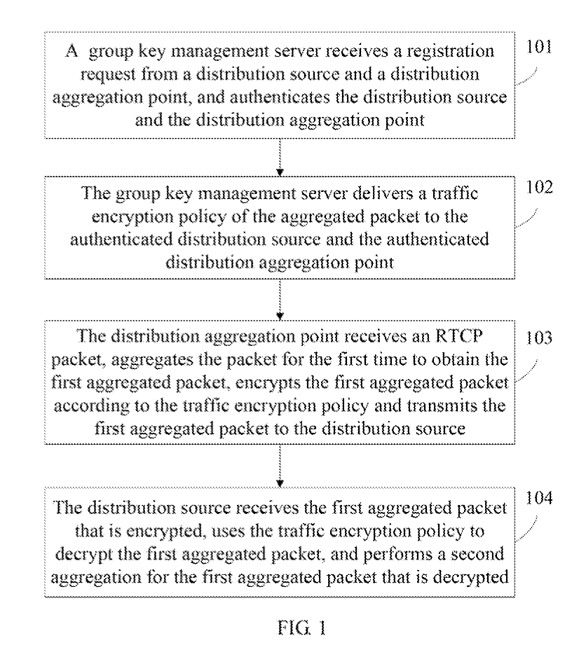

FIG. 1 is a flowchart of a method for managing multimedia services provided in the first embodiment of the present invention. The method includes the following steps:

Block 101: A group key management server receives a registration request from a distribution source and a distribution aggregation point, and authenticates the distribution source and the distribution aggregation point.

Block 102: The group key management server delivers a traffic encryption policy of the aggregated packet to the distribution source and distribution aggregation point that pass the authentication. The traffic encryption policy includes a traffic encryption key and algorithm parameters.

Block 103: The distribution aggregation point receives RR packet(s) from the corresponding session receivers, aggregates the packet(s) for the first time to obtain a first aggregated packet, encrypts the first aggregated packet by using the traffic encryption policy, and transmits the first aggregated packet to the distribution source.

Block 104: The distribution source receives the first aggregated packet that is encrypted, uses the traffic encryption policy to decrypt the first aggregated packet, and performs a second aggregation for the first aggregated packet that is decrypted. For example, the distribution source recovers the basic distribution information included in the first aggregated packet, and performs a second aggregation in best bandwidth mode or lossless data mode according to the basic distribution information to obtain a second aggregated packet.

Finally, the distribution source transmits the second aggregated packet. More specifically, the distribution source processes the second aggregated packet, generates an SR packet, and sends the packet to the session sender or the corresponding session receivers; or sends the second aggregated packet to the session sender directly. The processing of the second aggregated packet includes: resolving and collecting statistics on the key information such as delay and jitter information included in the second aggregated packet. When receiving the SR packet, the session sender delivers the packet to the corresponding session receivers directly; when receiving the second aggregated packet, the session sender processes the second aggregated packet, generates an SR packet, and then sends the SR packet to the session receivers.

Before the distribution aggregation point receives the RR packets from the corresponding session receivers, the method for managing multimedia services in this embodiment may further include: sending a notification about the location of the distribution aggregation point.

The first embodiment is detailed below:

Block (11): The session receiver uses the Feed Address Target Sub-Report in an RTCP packet to display the distribution aggregation point. SRBT is set to 2 and a universal distribution aggregation point domain name is written in the Address field. The session receiver needs to send a request to a Domain Name Server (DNS) before sending its own RR packet, requesting to resolve the domain name of the distribution aggregation point. The DNS balances load. For example, through a round robin technology, the DNS directs an RR packet to different distribution aggregation points.

Block (12): The group key management server sets up a group security management plane, receives the registration request from the distribution source and the distribution aggregation point, and checks the identity information (such as an X.509v3 certificate and a pre-shared key) about the registration requester. The distribution source and the distribution aggregation point which pass the authentication as legal set up a temporary secure channel with the group key management server. Through the temporary secure channel, the distribution aggregation point and the distribution source download the traffic encryption policy from the group key management server to a local directory through a Pull mechanism for encrypting or decrypting the first aggregated packet subsequently. For example, they download the traffic encryption key and the algorithm to a local directory. The Pull mechanism involves two point-to-point packet interactions so that the distribution source or the distribution aggregation point (both are known as endpoints) can update the traffic encryption policy (hereinafter referred to as “policy”) actively. Generally, the endpoint sends a request to the key server. The request includes the policies to be updated. After receiving the request, the key server delivers the policy to the endpoint. The Pull mechanism is generally triggered by expiry of the endpoint policy or is triggered when the endpoint believes that the policy is no longer secure. The two interactive packets of the Pull mechanism are protected by a secure channel. The secure channel is set up at the time of registering the endpoint.

Block (13): The distribution aggregation point receives the RR packet and aggregates the unicast RR packets from the receivers for the first time, namely, aggregates the unicast RR packets into an RSI packet, uses the encryption key to encrypt the RSI packet, and transmits the encrypted RSI packet to the distribution source.

Block (14): The distribution source receives the RSI packet, uses the traffic encryption policy to decrypt the RSI packet, and performs a second aggregation for the decrypted packet. The packet that is aggregated for the second time is still in an RSI packet format. The distribution source generates statistic information about the entire multicast RTP session. The statistic information is included in an SR packet, and delivered to each receiver of the multicast RTP session through multicast. The RSI packet describes various features of the session through data buckets, for example, packet loss ratio distribution, jitter distribution, and accumulated packet loss distribution. Because the sample packets of the distribution aggregation point may come from transmission networks with different features, the parameters of the data bucket may be different. The distribution source should recover the basic distribution information according to the received RSI packet first, perform a second aggregation in best bandwidth mode or lossless data mode according to the distribution information, form a new RSI packet, and transmit the new RSI packet. The transmitting operations on the new RSI packet may be performed as follows: The distribution source processes the new RSI packet, generates an SR packet, and sends the SR packet to the session sender or the corresponding session receivers; or transmits the new RSI packet to the session sender directly.

An alternative of block (11) is as follows:

An distribution aggregation point is deployed on the access node of an IPTV network, and the location of the distribution aggregation point is not displayed or notified to the session receiver. For example, the key parameters about the session are exchanged between the distribution source and the distribution aggregation point. Because the Protocol Independent Multicast Source Specific Multicast (PIM-SSM) is applied to the IPTV application and the key parameters include Distribute Source IP (DS IP) address and Distribute Source RTCP (DS RTCP) receiving port number, the location of the distribution aggregation point may be notified to the session receiver through a signaling protocol that carries a Service Discovery Protocol (SDP) connection information descriptor and a multimedia information descriptor.

Block (11) and its alternative are also applicable to the scenario of reusing the RTP and RTCP port.

The first embodiment deals with the method for managing multimedia services when the group key management server does not need to be updated. The multimedia service management method that involves the update of the key is described below.

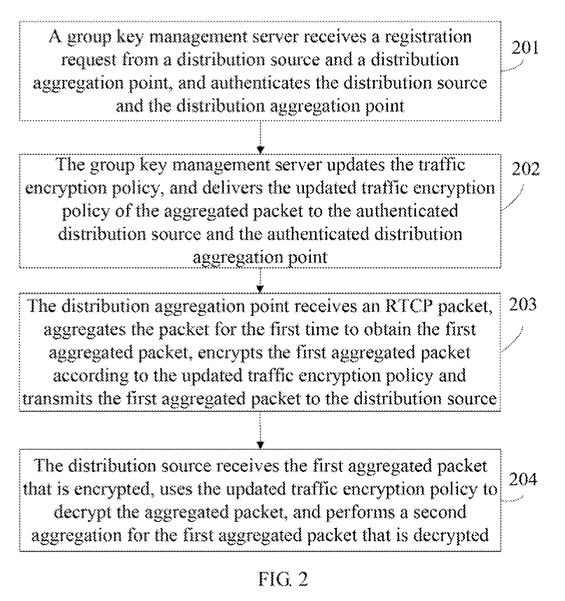

FIG. 2 is a flowchart of a multimedia service management method provided in another embodiment of the present invention. The method includes the following steps:

Block 201: A group key management server receives a registration request from a distribution source and a distribution aggregation point, and authenticates the distribution source and the distribution aggregation point.

Block 202: The group key management server updates the traffic encryption policy when a new distribution aggregation point joins the session, when an old distribution aggregation point leaves the session, or when the traffic encryption key expires or is cracked. The group key management server delivers the updated traffic encryption policy of the aggregated packet to the distribution source and the distribution aggregation point that pass the authentication. The traffic encryption policy includes a traffic encryption key and algorithm parameters.

Block 203: The distribution aggregation point receives RR packets from the corresponding session receivers, aggregates the packets for the first time to obtain a first aggregated packet, encrypts the first aggregated packet according to the updated traffic encryption policy, and transmits the first aggregated packet to the distribution source.

Block 204: The distribution source receives the first aggregated packet that is encrypted, uses the updated traffic encryption policy to decrypt the aggregated packet, performs a second aggregation for the first aggregated packet that is decrypted to obtain a second aggregated packet, and processes the second aggregated packet or transmits the second aggregated packet to the session sender directly. For example, the distribution source recovers the basic distribution information included in the first aggregated packet, and performs a second aggregation in best bandwidth mode or lossless data mode according to the distribution information to obtain the second aggregated packet. The distribution source transmits the second aggregated packet. More specifically, the distribution source processes the second aggregated packet, generates an SR packet, and sends the SR packet to the session sender or the corresponding session receivers; or sends the second aggregated packet to the session sender directly.

Before the distribution aggregation point receives the RR packets from the corresponding session receivers, the method may further include: sending a notification about the location of the distribution aggregation point.

The embodiment is detailed below:

Block (21): The session receiver uses the Feed Address Target Sub-Report in an RTCP packet to display the distribution aggregation point. SRBT is set to 2 and a universal distribution aggregation point domain name is written in the Address field. The session receiver needs to send a request to a DNS before sending its own RR packet, requesting to resolve the domain name of the distribution aggregation point. The DNS balances load. For example, through a round robin technology, the DNS directs the RR packet to different distribution aggregation points.

Block (22): The group key management server sets up a group security management plane, receives a registration request from the distribution source and the distribution aggregation point, and checks the identity information (such as an X.509v3 certificate and a pre-shared key) of the registration requester. The distribution source and distribution aggregation point which are authenticated as legal set up a temporary secure channel with the group key management server. Through the temporary secure channel, the distribution aggregation point and the distribution source download the traffic encryption policy from the group key management server to a local directory through a Pull mechanism for encrypting or decrypting the first aggregated packet subsequently. For example, they download the traffic encryption key and the algorithm to a local directory. After completion of the initial Pull process, when the new distribution aggregation point joins the session, or when the old distribution aggregation point leaves the session, or when the traffic encryption key expires or is cracked, the group key management server delivers the updated traffic encryption policy to the distribution aggregation point and distribution source dynamically-through a Push mechanism.

The group key management server needs to maintain a plurality of auxiliary sessions. Such auxiliary sessions are responsible for maintaining the registration process of the distribution aggregation point and the distribution source, and the Pull and Push processes of the traffic encryption policy. The distribution source and the distribution aggregation point perform encryption protection and integrity protection for the RSI packets through data sessions.

Block (23): The distribution aggregation point receives the RR packet and aggregates the unicast RR packets from the receivers for the first time, namely, aggregates the unicast RR packets into an RSI packet, uses the updated encryption key to encrypt the RSI packet, and transmits the encrypted RSI packet to the distribution source.

Block (24): The distribution source receives the RSI packet, uses the updated traffic encryption policy to decrypt the RSI packet, and performs a second aggregation for the decrypted packet. The reaggregated packet is still in an RSI packet format. The distribution source generates statistic information about the entire multicast RTP session. The statistic information is included in the SR packet, and delivered to each receiver of the multicast RTP session through multicast. The RSI packet describes various features of the session through data buckets, for example, packet loss ratio distribution, jitter distribution, and accumulated packet loss distribution. Because the sample packets of the distribution aggregation point may come from transmission networks with different features, the parameters of the data bucket are different, and the distribution source should recover the basic distribution information according to the received RSI packet first, perform a second aggregation in best bandwidth mode or lossless data mode according to the distribution information, form a new RSI packet, and transmit the new RSI packet. The transmitting operations on the new RSI packet may be performed as follows: The distribution source processes the new RSI packet, generates an SR packet, and sends the SR packet to the session sender or the corresponding session receivers; or transmits the new RSI packet to the session sender directly.

An alternative of step (21) is as follows:

The distribution aggregation point is deployed on the access node of the IPTV network, and the location of the distribution aggregation point is not displayed or notified to the session receiver. For example, the key parameters about the session are exchanged between the distribution source and the distribution aggregation point. Because PIM-SSM is applied to the IPTV application and the key parameters include DS IP address and DS RTCP receiving port number, the location of the distribution aggregation point may be notified to the session receiver through a signaling protocol that carries an SDP connection information descriptor and a multimedia information descriptor.

Step (21) and its alternative are also applicable to the scenario of reusing the RTP and RTCP port.

Described above is a method for managing multimedia services provided in an embodiment of the present invention. The following describes the system provided in an embodiment of the present invention.

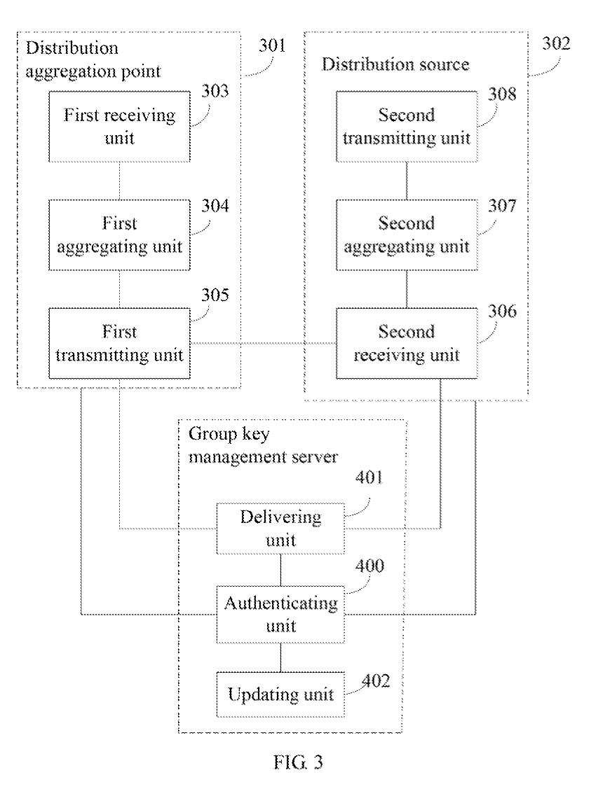

As shown in FIG. 3, a system for managing multimedia services is provided in this embodiment. The system may include: a distribution aggregation point 301 and a distribution source 302.

The distribution aggregation point 301 may include a first receiving unit 303, a first aggregating unit 304 and a first transmitting unit 305, where

the first receiving unit 303 is configured to receive an RR packet sent by a session receiver, where the RR packet is an RTCP packet;

the first aggregating unit 304 is configured to aggregate the packet for the first time to obtain a first aggregated packet; and

the first transmitting unit 305 is configured to transmit the first aggregated packet.

The distribution aggregation point may be deployed flexibly, for example, deployed on the access node of the IPTV network. As required, a new distribution aggregation point may join the session, or an old distribution aggregation point may leave the session.

The distribution source 302 may include a second receiving unit 306, a second aggregating unit 307, and a second transmitting unit 308, where

the second receiving unit 306 is configured to receive the first aggregated packet from the corresponding session receiver, where the first aggregated packet derives from aggregation of the RR packet received by the distribution aggregation point;

the second aggregating unit 307 is configured to aggregate the first aggregated packet received by the receiving unit for the second time to obtain a second aggregated packet; and

the second transmitting unit 308 is adapted to transmit the second aggregated packet.

Specifically, the transmitting operations are as follows: The second transmitting unit processes the second aggregated packet, generates an SR packet, and sends the SR packet to the session sender or the corresponding session receivers; or sends the second aggregated packet to the session sender directly. Accordingly, the second transmitting unit includes: a packet processing subunit, adapted to: process the second aggregated packet and generate an SR packet; and a packet sending subunit, adapted to send the second aggregated packet or the SR packet.

The system may further include a group key management server 309,

the group key management server 309 may includes an authenticating unit 400 and a delivering unit 401, where

the authenticating unit 400 is configured to: receive a registration request from the distribution aggregation point and the distribution source, and authenticate the distribution aggregation point and the distribution source; and

the delivering unit 401 is configured to deliver a traffic encryption policy of the aggregated packet to the requester authenticated successfully, where the traffic encryption policy includes a traffic encryption key and algorithm parameters.

The system may further include an updating unit 402, where:

the updating unit 402 is configured to update the traffic encryption policy. For example, when a new distribution aggregation point joins the session, when an old distribution aggregation point leaves the session, or when the traffic encryption key expires or is cracked, the group key management server downloads the updated traffic encryption key to the distribution aggregation point and the distribution source dynamically through a Push mechanism.

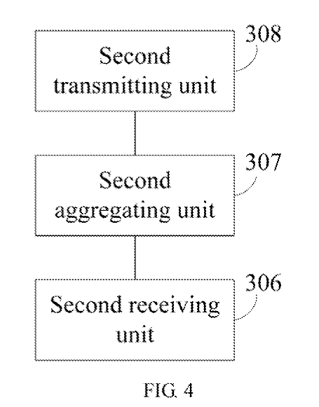

As shown in FIG. 4, an apparatus for managing multimedia services is provided in an embodiment of the present invention. The apparatus may include a second receiving unit 306, a second aggregating unit 307 and a second transmitting unit 308, where:

the second receiving unit 306 is configured to receive the first aggregated packet from the corresponding session receiver, where the first aggregated packet derives from aggregation of the RR packet received by the distribution aggregation point;

the second aggregating unit 307, adapted to aggregate the first aggregated packet received by the receiving unit for the second time to obtain a second aggregated packet; and

the second transmitting unit 308, adapted to transmit the second aggregated packet.

Specifically, the transmitting operations are as follows: The second transmitting unit processes the second aggregated packet, generates an SR packet, and sends the SR packet to the session sender or the corresponding session receivers; or sends the second aggregated packet to the session sender directly. Accordingly, the second transmitting unit includes: a packet processing subunit, adapted to: process the second aggregated packet and generate an SR packet; and a packet sending subunit, adapted to send the second aggregated packet or the SR packet.

In all embodiments, the location of the first aggregation and the location of the second aggregation are on two sides of the transmission network. Specifically, the location of the first aggregation is on the side of the session receiver on the transmission network, and the location of the second aggregation is on the side of the session sender on the transmission network.

In the technical solution of the embodiments of the present invention, a distribution aggregation point is introduced; a feedback packet at the session receiver is aggregated twice, and the packet processing load of the distribution source is reduced to the total number of the distribution aggregation points/report interval (Td); the operation toad undertaken by the distribution source in the related art is now undertaken by the distribution source and the distribution aggregation point jointly, thus implementing feedback of mass packets from the session receiver to the session sender and avoiding the unicast bottleneck caused by mass unicast packets. Secondly, distribution aggregation points are deployed flexibly, and the RR packets that come from the receiver are aggregated before entering the IPTV distribution network, thus reducing the load on the IPTV distribution network. For the network that has abundant bandwidths, the RTCP report interval is reduced, and the frequency of sampling the feedback packets of the RTCP is increased, and the real-time monitoring on the RTP multimedia transmission channel is enhanced. Thirdly, a secure group communication mechanism is applied. The group key management server authenticates the distribution aggregation point and the distribution source, and delivers a traffic encryption policy to the authenticated distribution aggregation point and distribution source. The distribution aggregation point uses the traffic encryption policy to encrypt the received RTCP packet before transmitting the packet. In this way, only the aggregation points that are authenticated successfully can join the secure group, and only the aggregated packets generated by the authenticated aggregation points are acceptable to the distribution source. The secure transmission of the aggregated packets of the distribution aggregation point from the distribution aggregation point to the distribution source ensures privacy and authenticity of the aggregated packets. Besides, when the distribution aggregation point changes, the traffic encryption policy is updated so that the real-time monitoring information of the RTP can be provided to the distribution source authentically.

Those skilled in the art are aware that all or part of the steps of the foregoing embodiments may be implemented by hardware instructed by a program. The program may be stored in a computer-readable storage medium such as a Read-Only Memory (ROM), a magnetic disk, or a Compact Disk (CD).

Detailed above are a method, an apparatus, and a system for managing multimedia services of the present invention. Although the invention is described through several exemplary embodiments, the invention is not limited to such embodiments. It is apparent that those skilled in the art can make modifications and variations to the invention without departing from the scope of the invention. The invention is intended to cover such modifications and variations provided that they fall in the scope of protection defined by the following claims or their equivalents.

What is claimed is:

1. A method for managing multimedia services, wherein: a distribution aggregation point is set near a receiver side and a distribution source is set at a sender side; and the method comprises:
receiving a first aggregated packet that is sent by the distribution aggregation point and obtained by aggregating a Real-time Transport Control Protocol (RTCP) packet sent by a receiver; and
performing a second aggregation on the first aggregated packet at the distribution source to obtain a second aggregated packet, and transmitting the second aggregated packet.

2. The method of claim 1, wherein a group key management server is set and the method further comprises:
by the group key management server, receiving a registration request from the distribution source and the distribution aggregation point, and authenticating the distribution source and the distribution aggregation point;
sending a traffic encryption policy of the first aggregated packet to the distribution source and the distribution aggregation point that pass the authentication;
by the distribution aggregation point, using the traffic encryption policy to encrypt the first aggregated packet before sending the first aggregated packet to the distribution source located at the session sender side; and
by the distribution source, using the traffic encryption policy to decrypt the first aggregated packet when receiving the first aggregated packet that is encrypted.

3. The method of claim 2, wherein before the distribution aggregation point receives the RTCP packet sent by a corresponding session receiver, the method further comprises:
sending, by the distribution aggregation point, a notification about the distribution aggregation point's location.

4. The method of claim 2, wherein:
the traffic encryption policy comprises a traffic encryption key and algorithm parameters.

5. The method of claim 2, wherein after the traffic encryption policy of the aggregated packet is delivered, the method further comprises:
updating the traffic encryption policy.

6. The method of claim 1, wherein the second aggregation for the first aggregated packet comprises:
recovering distribution information in the first aggregated packet; and
performing the second aggregation according to the distribution information.

7. The method of claim 2, wherein the second aggregation for the first aggregated packet comprises:
recovering distribution information in the first aggregated packet; and
performing the second aggregation according to the distribution information.

8. The method of claim 1, wherein the transmitting of the second aggregated packet comprises:
processing the second aggregated packet, generating a Sender Report (SR) packet, and sending the SR packet to the session sender or corresponding session receivers; or sending the second aggregated packet to the session sender directly.

9. The method of claim 2, wherein the transmitting of the second aggregated packet comprises:
processing the second aggregated packet, generating a Sender Report (SR) packet, and sending the SR packet to the session sender or corresponding session receivers; or sending the second aggregated packet to the session sender directly.

10. A system for managing multimedia services, comprising a distribution aggregation point and a distribution source, wherein:
the distribution aggregation point is located near a session receiver side, and the distribution aggregation point comprises a first receiving unit, a first aggregating unit, and a first transmitting unit, wherein
the first receiving unit is configured to receive a Real-time Transport Control Protocol (RTCP) packet sent by the session receiver;
the first aggregating unit is configured to aggregate the RTCP packet into a first aggregated packet; and
the first transmitting unit is configured to transmit the first aggregated packet;
the distribution source is located near a session sender side and the distribution source comprises a second receiving unit, a second aggregating unit and a second transmitting unit, wherein
the second receiving unit is configured to receive the first aggregated packet;
the second aggregating unit is configured to aggregate the first aggregated packet received by the second receiving unit to obtain a second aggregated packet; and
the second transmitting unit is configured to transmit the second aggregated packet.

11. The system of claim 10, further comprising a group key management server, wherein the group key management server comprises an authenticating unit and a delivering unit, wherein
the authenticating unit is configured to: receive a registration request from the distribution aggregation point and the distribution source, and authenticate the distribution aggregation point and the distribution source; and
the delivering unit is configured to deliver a traffic encryption policy of the first aggregated packet to a requester that is authenticated successfully.

12. The system of claim 11, further comprising an updating unit, wherein
the updating unit is configured to update the traffic encryption policy.

13. An apparatus for managing multimedia services, comprising a second receiving unit, a second aggregating unit and a second transmitting unit, wherein
the second receiving unit is configured to receive a first aggregated packet:
the second aggregating unit is configured to aggregate the first aggregated packet into a second aggregated packet: and
the second transmitting unit is configured to transmit the second aggregated packet.
